(19) United States
(12) Patent Application Publication
(10) Pub. No.: US 2007/0174094 A1
(43) Pub. Date: Jul. 26, 2007

(54) Evaluating a subrogation potential of an insurance claim

(75) Inventor: Mark S. Ramsey, Kihei, HI (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/338,414

(22) Filed: Jan. 24, 2006

(51) Int. Cl. G06Q 40/00; G06F 9/44

(52) U.S. Cl. 705/4; 705/7

(57) ABSTRACT

A method, system and computer program product for evaluating a subrogation potential of a target insurance claim is disclosed. A peer group of claims that are expected to include similar behaviors as the target claim and have been successfully subrogated is established to determine a normal behavior that the target claim is supposed to include. A behavior of the target claim is compared to the normal behavior to evaluate a subrogation potential of the target claim. Proper subrogation solutions are prospectively chosen based on the determined normal behavior to increase efficiency.

### FIELD OF THE INVENTION

The invention relates generally to a subrogation of an insurance claim, and more particularly to an evaluation of a subrogation potential of an insurance claim.

### BACKGROUND OF THE INVENTION

In the operation of an insurance business, the processing of claim function is a key to the financial performance and the customer satisfaction of the business. For example, in the case of home insurance, the claim function provides payment to an insured homeowner if a loss is incurred to the homer. As is understandable, a quick, reasonable payment will make the insured homeowner satisfactory, which may increase credibility and reliability of the insurance business. On the other hand, avoidance of an unreasonable or unwarranted payment to the insured homeowner will increase the financial solidity of the insurance business.

A common process of an insurance company to avoid unreasonable or unwarranted claim payments is referred to as subrogation, which identifies situations where a third party may share in the responsibility for an insured loss. For example, if a hot water heater leaks and floods an insured real estate, the insurance company needs to pay for the damage. However, if the insurance company identifies through, e.g., subrogation, that the hot water heater leakage is caused by manufacturing defects, the manufacturer may also be liable for the loss, which reduces the claim cost of the insurance company and also keeps the insurance cost of the homeowner from rising.

Regarding subrogation, an insurance company often finds itself in a dilemma. Attempting to subrogate all claims would be excessively expensive and time consuming, whereas missing an opportunity of sharing responsibility would unduly increase claim cost. For most insurance companies, claim costs constitute approximately 80 percent of the costs incurred in the operation, which has a significant impact to the insurance companies.

Based on the above, it is preferable that an insurance company can identify claims that have a high potential for subrogation to conduct subrogation selectively. The existing technology does not provide a successful solution to this question. As such, there is need for evaluating a subrogation potential of an insurance claim.

### BRIEF SUMMARY OF THE INVENTION

A method, system and computer program product for evaluating a subrogation potential of a target insurance claim is disclosed. A peer group of claims that are expected to include similar behaviors as the target claim and have been successfully subrogated is established to determine a normal behavior that the target claim is supposed to include. A behavior of the target claim is compared to the normal behavior to evaluate a subrogation potential of the target claim. Proper subrogation solutions are prospectively chosen based on the determined normal behavior to increase efficiency.

A first aspect of the invention is directed to a method for evaluating a subrogation potential of a target claim for insurance payment, the method comprising steps of: selecting a peer group of claims that are expected to include a similar behavior as the target claim and have been successfully subrogated; identifying a set of behavioral attributes of the peer group; determining a normal behavior of the peer group regarding the identified set of behavioral attributes; and comparing a behavior of the target claim to the normal behavior regarding the identified set of behavior attributes to evaluate the subrogation potential of the target claim.

A second aspect of the invention is directed to a system for evaluating a subrogation potential of a target claim for insurance payment, the system comprising: means for selecting a peer group of claims that are expected to include a similar behavior as the target claim and have been successfully subrogated; means for identifying a set of behavioral attributes of the peer group; means for determining a normal behavior of the peer group regarding the identified set of behavioral attributes; and means for comparing a behavior of the target claim to the normal behavior regarding the identified set of behavior attributes to evaluate the subrogation potential of the target claim.

A third aspect of the invention is directed to a computer program product for evaluating a subrogation potential of a target claim for insurance payment, the computer program product comprising: computer usable program code configured to: select a peer group of claims that are expected to include a similar behavior as the target claim and have been successfully subrogated; identify a set of behavioral attributes of the peer group; determine a normal behavior of the peer group regarding the identified set of behavioral attributes; and compare a behavior of the target claim to the normal behavior regarding the identified set of behavior attributes to evaluate the subrogation potential of the target claim.

A fourth aspect of the invention is directed to a method of generating a system for evaluating a subrogation potential of a target claim for insurance payment, the method comprising: providing a computer infrastructure operable to: select a peer group of claims that are expected to include a similar behavior as the target claim and have been successfully subrogated; identify a set of behavioral attributes of the peer group; determine a normal behavior of the peer group regarding the identified set of behavioral attributes; compare a behavior of the target claim to the normal behavior regarding the identified set of behavior attributes to evaluate the subrogation potential of the target claim; and communicate a result of the evaluation to a customer insurance company.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

The embodiments of this invention will be described in detail, with reference to the following figures, wherein like designations denote like elements, and wherein:

FIG. 1 shows a schematic view of an illustrative insurance claim subrogating system according to one embodiment of the invention.

FIG. 2 shows a block diagram of an illustrative computer system according to one embodiment of the invention

FIG. 3 shows a flow diagram of one embodiment of the operation of a claim subrogation potential evaluating system according to the invention.

FIG. 4 shows an illustrative example of a hierarchical structure of claim attributes according to the invention.

FIG. 5 shows an illustrative example of a data table of behavioral attributes and subrogation solutions according to one embodiment of the invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

1. System Overview

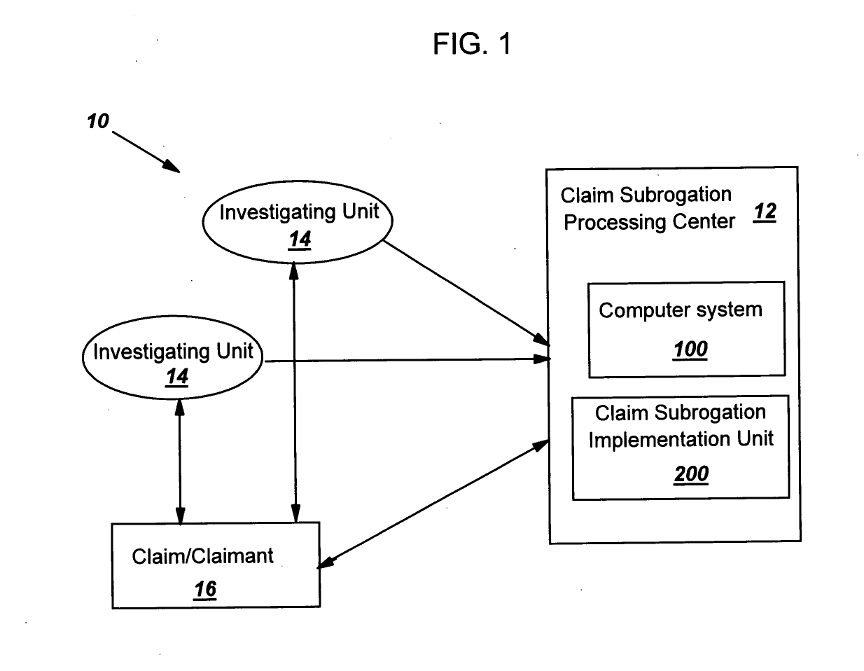

Referring to FIG. 1, a schematic view of an illustrative insurance claim subrogating system 10 is shown. According to one embodiment, subrogating system 10 includes a claim subrogation processing center 12 including a computer system 100 and a claim subrogation implementation unit 200; and multiple investigating units 14 (two are shown). Investigating units 14 collect information regarding claim 16, including, for example, time of loss, time of report, type of loss, type of claim, actions taken by claimant 16, etc. Investigating units 14 may include any persons or devices employed by an insurance company for investigating an insurance claim regarding issues that are related to the processing of the claim by the insurance company. For example, investigating units 14 may be an investigator who is employed by an insurance company and works to investigate issue related to the processing of a claim. A claim appraiser may also be a convenient candidate to perform the functions of investigating units 14. According to one embodiment, investigating units 14 may also conduct a claim subrogation process according to the instructions of claim subrogation implementation unit 200 and may feedback the outcomes of the subrogation process to computer system 100. For example, investigating units 14 may communicate to computer system 100 whether they successfully find a third party to share responsibility through the claim subrogation process.

Claim/claimant 16 may communicate with processing center 12 regarding, for example, loss and claim information, for example, time of loss, type of loss, any measures taken to reduce loss, amount of loss, and the context of the loss. Claimant 16 may also communicate with investigating units 14 in the process of data collecting. For example, claimant 16 may be interviewed by investigating unit 14 regarding the context of the loss and measures taken to reduce loss, and may be requested to provide police reports, product warranty documents, or other information that can be used in the investigation.

According to one embodiment, in the following description of subrogation system 10, a claim and a claimant are taken as matching one-to-one to each other. Specifically, in subrogation system 10, a claim is always a claimant's claim, and a claimant is always a claim's claimant. If an individual submits two claims, the individual is treated as two claimants regarding the two claims. If a claim has more than one beneficiaries, e.g., joint beneficiaries, the more than one beneficiaries are treated as one claimant for simplicity purpose. As such, in FIG. 1, a claim and a claimant are similarly marked as 16. In subrogating system 10, a target claim 16 is generally a claim 16. However, for illustrative purpose, in the following description, a claim 16 is referred to as a target claim 16 when this claim 16 is processed by claim subrogation processing center 12, i.e., when this specific claim 16 is evaluated regarding a subrogation potential. Similarly, the claimant of target claim 16 is referred to as target claimant 16, for illustrative purpose only. It should be noted that in subrogating system 10, regardless of whether a claim 16 is a target claim 16, data regarding the claim 16 will be collected because: (a) any claim may potentially become a target claim, and (b) any claim may potentially be selected into a peer group as described later.

In operation, claim 16 submitted from claimant 16 may be communicated to computer system 100 of processing center 12 to evaluate whether the claim has potential of subrogation. If computer system 100 obtains a positive evaluation result, i.e., the claim has potential of subrogation, the evaluation result will be communicated to claim subrogation implementation unit 200 to implement a subrogation process. Details of computer system 100 of processing center 12 will be described below.

2. Computer System

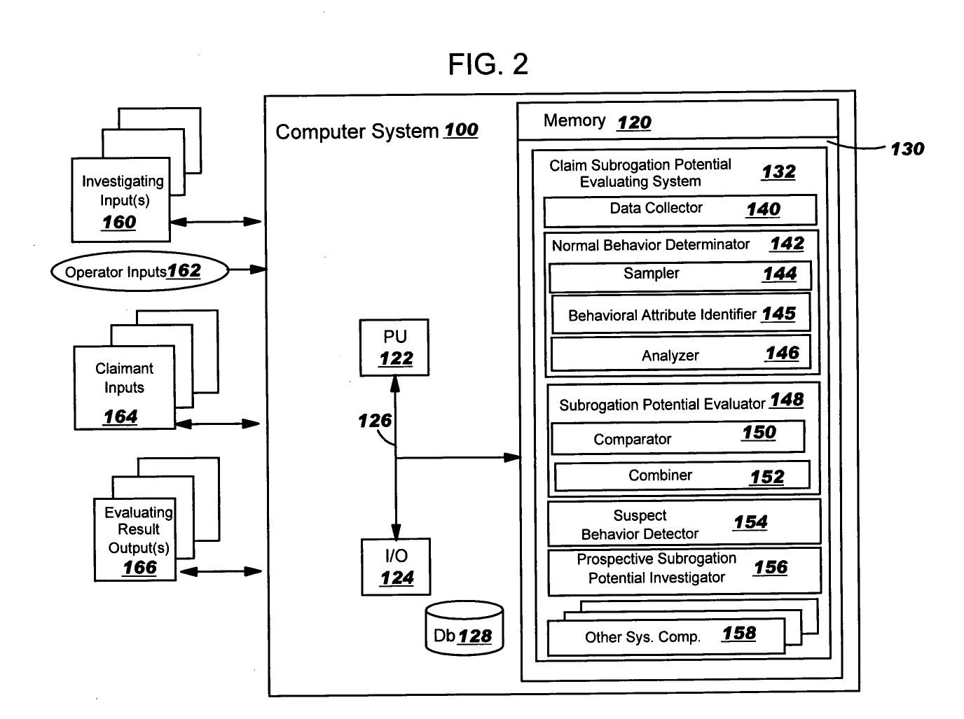

Referring to FIG. 2, a block diagram of an illustrative computer system 100 according to the present invention is shown. In one embodiment, computer system 100 includes a memory 120, a processing unit (PU) 122, input/output devices (I/0) 124 and a bus 126. A database 128 may also be provided for storage of data relative to processing tasks. Memory 120 includes a program product 130 that, when executed by PU 122, comprises various functional capabilities described in further detail below. Memory 120 (and database 128) may comprise any known type of data storage system and/or transmission media, including magnetic media, optical media, random access memory (RAM), read only memory (ROM), a data target, etc. Moreover, memory 120 (and database 128) may reside at a single physical location comprising one or more types of data storage, or be distributed across a plurality of physical systems. PU 122 may likewise comprise a single processing unit, or a plurality of processing units distributed across one or more locations. I/O 124 may comprise any known type of input/output device including a network system, modem, keyboard, mouse, scanner, voice recognition system, CRT, printer, disc drives, etc. Additional components, such as cache memory, communication systems, system software, etc., may also be incorporated into computer system 100.

As shown in FIG. 2, program product 130 may include a claim subrogation potential evaluating system 132 that includes a data collector 140; a normal behavior determinator 142 including a sampler 144, a behavioral attribute identifier 145 and an analyzer 146; a subrogation potential evaluator 148 including a comparator 150 and a combiner 152; a suspect behavior detector 154; a prospective subrogation potential investigator 156; and other system components 158. Other system components 158 may include any now known or later developed parts of a computer system 100 not individually delineated herein, but understood by those skilled in the art.

Inputs to computer system 100 include investigating inputs 160, operator inputs 162 and claimant inputs 164. Investigating inputs 160 include the data collected by investigating units 14 (FIG. 1). Operator inputs 162 include instructions of an operator of computer system 100 regarding the operation of, inter alia, claim subrogation potential evaluating system 132, as will be described in detail below. Claimant inputs 164 include information regarding claim 16 that is reported by claimant 16 (FIG. 1). Those inputs may be communicated to computer system 100 through I/O 124 and may be stored in database 128. Outputs of computer system 100 include evaluating result outputs 166 that are communicated to, inter alia, claim subrogation implementation unit 200 for it to act accordingly. The information provided by investigating units 14 through investigating inputs 160 and by claimants 16 through claimant inputs 164 might overlap and the contradict. In this situation, the information from investigating units 14 is relied by claim subrogation potential evaluating system 132 in evaluating a subrogation potential of target claim 16 because investigating units 14 are supposed to be more reliable than claimants 16 regarding a claim submitted. In addition, a divergence between the information provided by investigating units 14 and claimant 16 may be used to detect an abnormal behavior of the claim submitted by claimant 16 in a prospective analysis of claim subrogation potential evaluating system 132, as will be described later. The operation of claim subrogation potential evaluating system 132 will be described in details below.

3. Claim Subrogation Potential Evaluating System

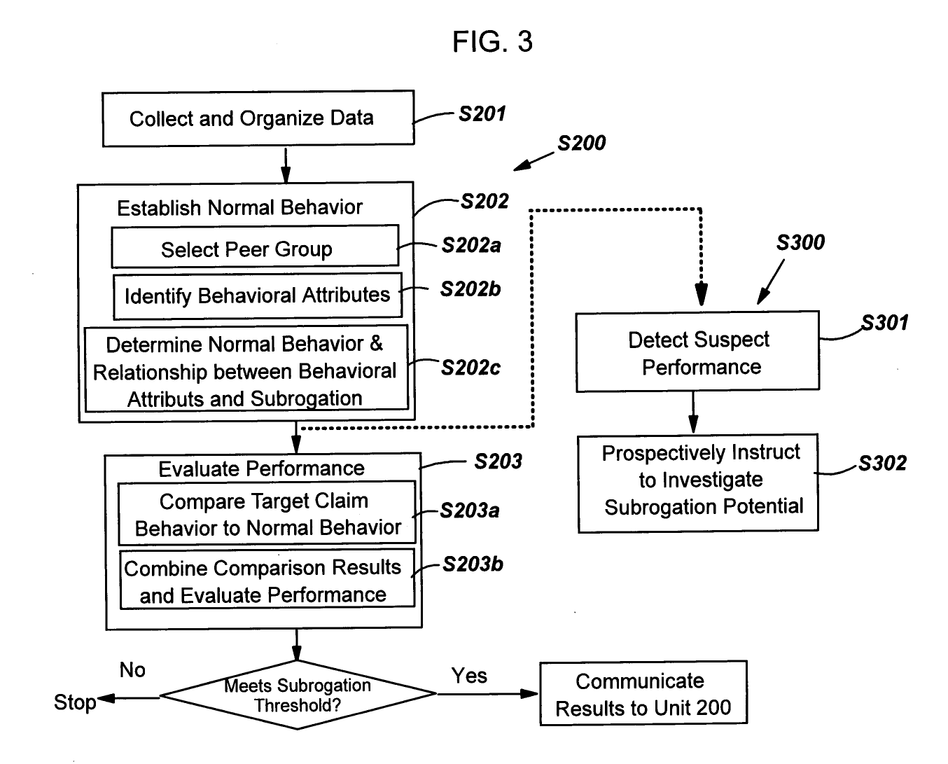

Claim subrogation potential evaluating system 132 functions generally to evaluate whether a claim has the potential of subrogation, i.e., a process to identify whether a third party may share the responsibility for the claimed loss. One embodiment of the operation of claim subrogation potential evaluating system 132 is shown in the flow diagram of FIG. 3.

According to one embodiment, the operation of claim subrogation potential evaluating system 132 includes a historic analysis and a prospective analysis. Referring also to FIG. 1, the historic analysis operation occurs usually after investigating units 14 have finished an investigation of target claim 16 and obtained all the information needed for evaluating the subrogation potential of target claim 16. The prospective analysis operation usually occurs after target claim 16 is submitted, but before investigating units 14 finish an investigation of target claim 16. One objective of the prospective analysis operation is to prospectively detect an abnormality of target claim 16 so that investigating units 14 and/or claim subrogation implementation unit 200 may respond accordingly before unnecessary investigations have been performed. For example, investigating units 14 may pay more attention to the information related to the detected abnormality and/or possible subrogation solutions related to the abnormality to increase efficiency. An embodiment of the operation of claim subrogation potential evaluating system 132 regarding the historical analysis and the prospective analysis will be shown in the flow diagram of FIG. 3.

Referring now to FIG. 3, with reference also to FIG. 2, according to one embodiment, the historic analysis is represented by step S200 including steps S201 to S203; and the prospective analysis is represented by step S300 including steps S301 to S302. Specifically, with respect to step 200, first in step S201, data collector 140 collects data and organizes the data to facilitate a further statistical analysis of the data. The data collected include those of investigating inputs 160 and claimant inputs 164. Data collector 140 collects data of all claims submitted to an insurance company that employs processing center 12 (FIG. 1). As is described above, investigating units 14 may also conduct subrogation process and communicate the results of the subrogation process, e.g., whether a third party is identified through the subrogation process, to computer system 100 through investigating inputs 160. As such, the data collected may also include subrogation results of claims 16, if a subrogation process had been done with claims 16. Please note, as is understandable, there will not be subrogation results information regarding target claim 16, because target claim 16 has not been subrogated. According to one embodiment, the data collected include all the data regarding claim 16 for processing an insurance payment and the additional data for processing a claim subrogation. For example, the data may include information regarding the loss of the property, actions taken after the loss including those taken to reduce further loss, claiming process, and other details of the claim. In the following description, the information collected by data collector 140 will be referred to as claim attributes, for illustrative purpose only. The claim attributes may have continuous data value or categorized data value such as “yes/no” or “1/0”. The data value of a claim attribute is referred to as a behavior regarding the claim attribute in the following description, for illustrative purpose only.

For each specific claim 16 (FIG. 1), claim attribute data might have some problems such as missing data or obviously strange data. Those problems need to be resolved by data collector 140 in step S201 before the problematic data is used for further analysis. Claim attribute data may also need to be treated in step S201 to fit an analysis purpose. For example, in some situations, a categorized type of data might be more suitable than a data of continuous value, so continuous claim attribute data may need to be converted to categorized data in step S201.

Next in step S202, normal behavior determinator 142 determines a normal behavior of a peer group of claims 16 that are expected to include similar behaviors regarding a certain claim attributes as target claim 16 (FIG. 1) and have been successfully subrogated. Specifically, in step S202a, sampler 144 establishes/selects a peer group of claims 16, which are expected to include the same (or similar) behaviors regarding a certain claim attributes and have been successfully subrogated. Generally speaking, definition of a peer group for a specific target claim 16 is based on homogeneous or similar behaviors regarding claim attributes among target claim 16 and other claims 16 that have been successfully subrogated. For example, if target claim 16 claims loss of household property due to hot water heater explosion, other claims (16) of loss of household property due to hot water heater explosion and have been successfully subrogated may be selected to constitute the peer group.

Any claim attribute may be used as the basis to define a peer group if the homogeneity in this claim attribute may predict similarity in other claim attributes. However, claim attributes that are related to (or affect) subrogation potential are usually not preferable to define peer group because behaviors regarding those claim attributes will be analyzed in the evaluation of subrogation potential of target claim 16. As is understandable, any claim attribute that is used to define a peer group will not be analyzed among the peer group, because the homogeneity regarding this claim attribute is given. According to one embodiment, a classification of claims in the insurance company that claim 16 is submitted to maybe used to define a peer group to facilitate the administration of the claim processing.

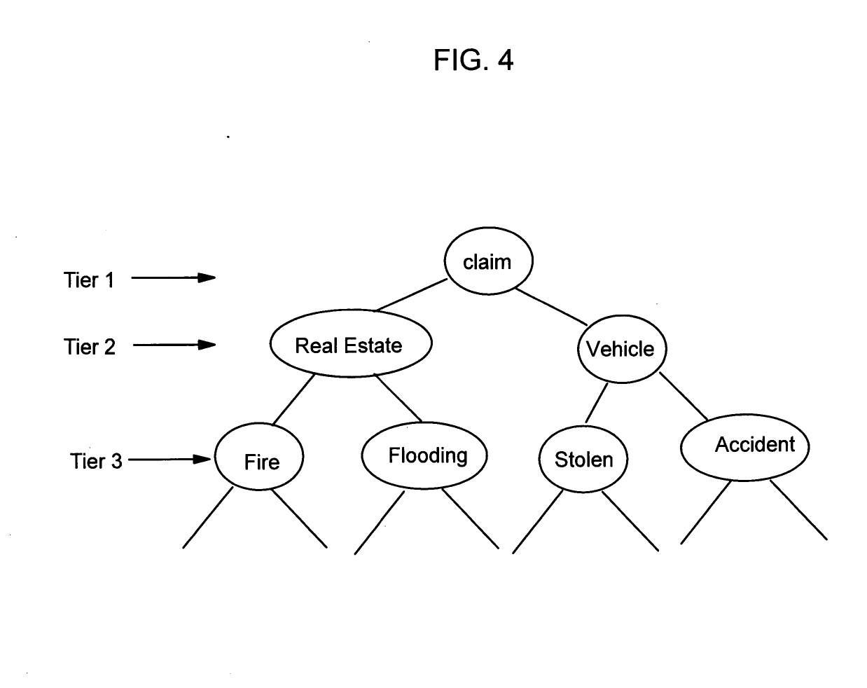

Please note, claim attribute data may be described as a hierarchical structure like the illustrative example shown in FIG. 4. As is understandable, the more claim attributes are used for defining a peer group, the more homogeneous the peer group is and the more specific an analysis is based on the peer group. Referring to the example of FIG. 4, please note, however, the operation of claim subrogation potential evaluating system 132 can be operated in any tiers of peer groups. For example, if a peer group in established in tier 1, i.e., all claims, whether a real estate related claim or a vehicle related claim have more potential of subrogation may be determined according to the operation described below; if a peer group is established in tier 2 level, e.g., all real estate claim, whether a fire related real estate damage or a flooding related real estate damage has more potential of subrogation may be determined. In the following description, claim attributes that are used to define a peer group are referred to as sampling attributes, for descriptive purpose only.

It should also be noted that the selection of a peer group is conducted by evaluating system 132, specifically sampler 144, independent of interventions of claimants 16 (FIG. 1). According to one embodiment, no information regarding the peer group selection, for example, standard, procedure, and/or results, will be communicated to claimant 16. This is to ensure that target claimant 16 and other claimants 16 of claims 16 that have the possibility of being selected into a peer group will not coordinate in a fraudulent type of actions, which will be more difficult to detect.

According to one embodiment, in step S202a, sampler 144 first identifies a pool of all the claims 16 based on their homogeneity in the sampling attributes as target claim 16. Next, sampler 144 selects among the pool those claims 16 that have already successfully gone through subrogation processes (e.g., identified at least one third party that is responsible for the claimed loss) to generate a modified pool. According to one embodiment, sampler 144 only selects claims 16 that were randomly selected to be subrogated to establish the modified pool, to reduce systematic sampling errors, as is understandable. Next, sampler 144 samples a peer group from the modified pool. One reason for sampling a peer group from the modified pool is to save system resources of computer system 100 (FIG. 2), for example, the memory space required for further calculation. It should be understood that in some situations, sampling may not be necessary or may not be desirable. For example, if the modified pool itself is not big or if the potential sampling errors are not acceptable, the modified pool itself may be used as the peer group. The sampling may use any now known or future developed methods of sampling, for example, random sampling or representative sampling.

Next in step S202b, behavioral attribute identifier 145 identifies a set of claim attributes regarding which target claim 16, if it has subrogation potential, is expected to include similar behavior as the peer group identified in step S202a. The identified set of claim attributes is referred to as behavioral attributes, for illustrative purpose only. For a specific target claim 16, it may not be expected that it includes similar behaviors regarding all claim attributes as the peer group, if it has subrogation potential, instead it may be expected that target claim 16 includes similar behaviors regarding some claim attributes as the peer group. In addition, even if target claim 16 is expected to include similar behaviors regarding all claim attributes, not all claim attributes are of concern for target claim 16 in a specific evaluation.

According to one embodiment, the selection of behavioral attributes may be based on statistical analysis of the peer group behaviors regarding claim attributes. For example, a standard deviation of the peer group behaviors regarding a specific claim attribute may be compared to a threshold, for example, standard deviation being less than 10 percent of mean. If the standard deviation of the peer group behaviors regarding a specific claim attribute meets the threshold, that specific claim attribute may be selected as a behavioral attribute.

According to an alternative embodiment, the selection of behavioral attributes may be based on identified “contributing” claim attributes that are related to claim subrogation potential. For example, if based on past records, it is established that a set of claim attributes, for example, in the case of fire damage in a house, time between loss and submission of claim and actions taken after accident to reduce further loss are related to (contributing to) the outcomes of claim subrogation processes, this set of claim attributes may be selected, among others, as the behavioral attributes. For another example, in the case of car accident, location of accident, time between accident and report to insurer, amount of loss, whether a third part was involved, whether a police report was filed, whether claimant 16 was at fault, and number of parties involved may be selected, among others, as the behavioral attributes. It should be noted that any now known or later developed methods of selecting behavior attributes are also included in the current invention and may be used independently, or in combination, in selecting behavioral attributes.

Please note, step S202b is not necessarily conducted after step S202a. According to an alternative embodiment, claim subrogation potential evaluating system 132 may identifies the behavioral attributes before selecting a peer group. In this situation, the selection of peer group may be based on a similarity between and among target claim 16 and other claims 16 with respect to claim attributes other than the set of behavioral attributes.

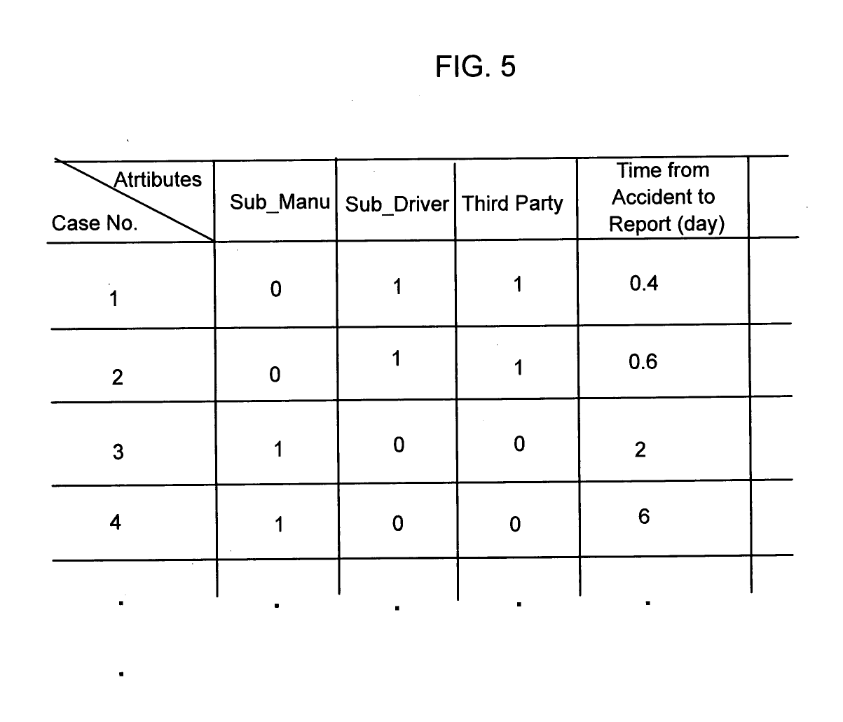

According to one embodiment, behavioral attribute data and the subrogation result data may be arranged in a table. FIG. 5 shows an illustrative example of the data table of an illustrative peer group of car accident claims. Referring now to FIG. 5, as is understandable, in a subrogation process, more than one subrogation solution may be tried. For example, for a car accident claim (16), investigating units 14 (FIG. 1) may attempt to identify the manufacturer of the cars involved as responsible for the claimed loss (SUB_Manu), or may attempt to identify another driver as negligence in causing the accident (SUB_Driver). If a responsible third party is identified through at least one of the subrogation solutions, claim 16 is considered successfully subrogated. Subrogation results may be indicated by binary codes. For example, as shown in FIG. 5, value “1” may be used to indicate a positive subrogation result, e.g., successfully identifies a responsible third party, and value “0” may be used to indicate a negative subrogation result, e.g., no third party is identified as responsible.

Next in step S202c, analyzer 146 determines a normal behavior of the peer group selected in step S202a, regarding the set of behavioral attributes identified in step S202b. In step S202c, analyzer 146 may also determines a relationship between the identified behavioral attributes to the outcomes of subrogation.

Various methods may be used to determine the normal behavior. According to one embodiment, the average of the behaviors of the peer group regarding a behavioral attribute may be selected as the normal behavior regarding this behavioral attribute. The average of the peer group may be either the mean or the median depending on a specific target claim 16 and a specific evaluation. According to one embodiment, the mean of the behaviors of the peer group of claims 16 is a better choice to be used as the normal behavior because a standard deviation is calculated based on the mean, instead of the median. As will be described below, a standard deviation may be used in further analysis, such as a score normalization procedure. It should be noted that any now existing and later developed methods of determining a normal behavior are included in the scope of the present invention.

According to one embodiment, the relationship between a behavioral attribute and an outcome of subrogation may be determined by determining a statistical relationship between a specific subrogation solution and the behavioral attribute, such as a correlation or a regression equation. For example, using the example of data table shown in FIG. 5, the relationship between behavioral attribute “time from accident to report” to subrogation outcomes may be determined by determine a correlation between “time from accident to report” and “Sub_Manu” and between “time from accident to report” to “Sub_Driver”. It should be noted that any now known and later developed methods of determining a relationship between a behavioral attribute and subrogation solutions are all included in the present invention.

Please be noted, step S202 does not need to be conducted after computer system 100 receives/collects all the data regarding target claim 16. Instead, step S202 may be conducted any time before. For example, an insurance company employing processing center 12 may established a peer group based on its own classification of claims and obtain the normal behavior and the relationship between behavior attributes and subrogation solutions before claim subrogation potential evaluating system 132 is operated to evaluate the subrogation potential of target claim 16. For example, the peer group and normal behavior may be established during system setup, and may be saved in database 128 for future reference.

It should be also noted, the procedure of the determination of the relationship between a behavioral attribute and a subrogation solution may also be used to select a behavioral attribute. For example, a relationship between a claim attribute and a subrogation solution may be used to determine whether the claim attribute can be selected as a behavioral attribute. If it is determined that the claim attribute is related to the outcome of the subrogation solution, e.g., a correlation exists, the behavioral attribute can be selected as a behavioral attribute.

Next in step S203, subrogation potential evaluator 148 evaluates a subrogation potential of target claim 16. Specifically, in step S203a, comparator 150 compares the behavior of target claim 16 with the normal behavior determined in step S202 regarding each of the identified set of behavioral attributes. The specific procedure of the comparison depends on how the normal behavior is determined in step S202c. According to one embodiment, if the normal behavior is determined using the mean of the peer group behaviors regarding each identified behavioral attribute, comparator 150 compares the behavior of target claim 16 with the normal behavior with respect to each of the identified set of behavioral attributes. The difference between the behavior of target claim 16 and the normal behavior with respect to each behavioral attribute may be converted into a 0 to 1000 score, in a manner that a bigger difference is converted to a higher score. It should be noted that any score normalization procedures (methods) may be used in the conversion and is included in the current invention. Because the details regarding the conversion are not necessary for an understanding of the current invention, no further details will be provided.

Next in step S203b, combiner 152 combines the comparison results, i.e., the scores, with respect to each behavioral attribute to generate an overall comparison result, i.e., a combined score. A low combined score indicates that target claim 16 conforms to the norm, which predicts that target claim 16 has the potential of subrogation. Please note, the peer group is selected from claims 16 that have been successfully subrogated and the normal behavior is the norm of claims that have subrogation potential. The combined score may be compared to a threshold to determine whether target claim 16 has the potential to be subrogated. If the combined score is lower than the threshold, i.e., meets the threshold, target 16 is considered having subrogation potential and computer system 100 will communicate the result to claim subrogation implementation unit 200 to implement a subrogation process (FIG. 1).

According to one embodiment, the combined scores of more than one target claims 16 may be ranked in a list of claims waiting for subrogation. Claim 16 with lowest combined score, i.e., highest subrogation potential, is put on the top of the list. Due to limited resources, an insurance company may not subrogate all of the target claims 16, but will select claims 16 to be subrogated from the top of the list.

According to one embodiment, the combined score is obtained by averaging the scores obtained regarding each individual behavioral attributes. According to an alternative embodiment, the score with respect to a behavioral attribute is first weighed according to the behavioral attribute's relative importance in evaluating subrogation potential before the score is combined with others to obtain a combined score.

In addition, an individual score regarding an individual behavioral attribute may also be used to evaluate whether target claim 16 has the potential to be subrogated for a specific subrogation solution, if the behavioral attribute has been determined as related to the specific subrogation solution, in step S202c.

The results of the evaluation, e.g., the combined scores and the individual scores may be communicated to, for example, claim subrogation implementation unit 200 (FIG. 1) though, for example, evaluation results outputs 166. In addition, if the operation of claim subrogation potential evaluating system 132 is provided as a service to a customer insurance company, the results of the evaluation, e.g., the individual and the combined scores, may be communicated to the customer insurance company through, e.g., evaluation results outputs 166.

With respect to the prospective analysis, according to the embodiment shown in FIG. 3, step S300 includes two steps S301 and S302. Please note, step S300 occurs before all claim attribute data of target claim 16 have been collected. As such, according to one embodiment, the prospective analysis operation only evaluates target claim 16 regarding individual behavioral attributes, but not their combination. In addition, results of the historic analysis, e.g., the peer group and the normal behaviors, may be used as a basis for the prospective analysis.

Specifically, in step S301, suspect behavior detector 154 detects a suspect behavior of a target claim 16. According to one embodiment, suspect behavior detector 154 compares the behavior of target claim 16 to the normal behavior regarding the behavioral attributes identified in step S202, using the available data of target claim 16. If the comparison shows that target claim 16 includes an suspect behavior, i.e., a behavior similar to the normal behavior, regarding at least one behavioral attribute, which predicts subrogation potential, the prospective analysis will proceed to step S302. If the comparison shows that target claim 16 does not include a suspect behavior regarding any of the behavioral attributes, based on the available information, prospective analysis will pause to wait for more information regarding target claim 16.

Next in step S302, prospective subrogation potential investigator 156 instructs investigating units 14 (FIG. 1) to investigate target claim 16 purposefully regarding subrogation potential. For example, if in step S301, target claim 16 is determined to include a suspect behavior regarding a specific behavioral attribute that has been determined in step S202c of the historic analysis to be related to a specific subrogation solution, prospective subrogation potential investigator 156 may instruct investigating units 14 to pay more attention to investigate the potential of the specific subrogation solution. For another example, if in step S301, target claim 16 is determined to include a suspect behavior regarding a specific behavioral attribute that has not been determined in step S202c of the historic analysis to be related to any specific subrogation solution, prospective subrogation potential investigator 156 may instruct investigating units 14 to pay generally more attention to investigate subrogation potential.

Please note, in the description of the operation of claim subrogation potential evaluating system 132, the historic analysis (step S200) is discussed before the prospective analysis (step S300). This order of description is used only for illustrative purpose because the prospective analysis is based on the peer group and the normal behavior determined in the historic analysis. However, for the processing of a specific target claim 16 (FIG. 1), the prospective analysis may occur before the historic analysis. For example, in a computer system 100, the peer group and the normal behavior of the historic analysis may have already been established (through, e.g., a previous historic analysis operations or a system setup) and are saved in database 128 (FIG. 2). Regarding a specific target claim 16, claim subrogation potential evaluating system 132 may first begin a prospective analysis using available information regarding target claim 16 and may iterate the prospective analysis as more information is collected until all the information required for a historic analysis is collected, when evaluating system 132 may begin and complete the historic analysis.

4. Conclusion

While shown and described herein as a method and system for evaluating a subrogation potential of an insurance claim, it is understood that the invention further provides various alternative embodiments. For example, in one embodiment, the invention provides a program product stored on a computer-readable medium, which when executed, enables a computer infrastructure to evaluate a subrogation potential of an insurance claim. To this extent, the computer-readable medium includes program code, such as claim subrogation potential evaluating system 132 (FIG. 2), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 120 (FIG. 2) and/or database 128 (FIG. 2), and/or as a data signal traveling over a network (e.g., during a wired/wireless electronic distribution of the program product).

In another embodiment, the invention provides a method of generating a system for evaluating a subrogation potential of an insurance claim. In this case, a computer infrastructure, such as computer system 100 (FIG. 2), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing system 100 (FIG. 2), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising supported, and/or fee basis. That is, a service provider could offer to evaluate a subrogation potential of an insurance claim as described herein. In this case, the service provider can manage (e.g., create, maintain, support, etc.) a computer infrastructure, such as computer system 100 (FIG. 2), that performs the process described herein for one or more customers and communicates the results of the evaluation to the one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for evaluating a subrogation potential of a target claim for insurance payment, the method comprising steps of:
selecting a peer group of claims that are expected to include a similar behavior as the target claim and have been successfully subrogated;
identifying a set of behavioral attributes of the peer group;
determining a normal behavior of the peer group regarding the identified set of behavioral attributes; and
comparing a behavior of the target claim to the normal behavior regarding the identified set of behavior attributes to evaluate the subrogation potential of the target claim.

2. The method of claim 1, wherein the normal behavior determining step includes collecting behaviors of the peer group and analyzing the collected behaviors of the peer group regarding the identified set of behavioral attributes.

3. The method of claim 1, wherein the comparing step includes steps of:
comparing the behavior of the target claim with the normal behavior with respect to each of the identified set of behavioral attributes; and
combining a result of the comparison with respect to each of the identified set of behavioral attributes to generate an overall comparison result.

4. The method of claim 1, wherein the peer group selecting step includes a step of determining a similarity between and among the target claim and other claims for insurance payment with respect to claim attributes other than the set of behavioral attributes.

5. The method of claim 1, further including a step of prospectively investigating the subrogation potential based on a result of the comparing step.

6. A system for evaluating a subrogation potential of a target claim for insurance payment, the system comprising:
means for selecting a peer group of claims that are expected to include a similar behavior as the target claim and have been successfully subrogated;
means for identifying a set of behavioral attributes of the peer group;
means for determining a normal behavior of the peer group regarding the identified set of behavioral attributes; and
means for comparing a behavior of the target claim to the normal behavior regarding the identified set of behavior attributes to evaluate the subrogation potential of the target claim.

7. The system of claim 6, further including:
means for collecting behaviors of the peer group; and
means for analyzing the collected behaviors of the peer group regarding the identified set of behavioral attributes.

8. The system of claim 6, further including:
means for comparing the behavior of the target claim with the normal behavior with respect to each of the identified set of behavioral attributes; and
means for combining a result of the comparison with respect to each of the identified set of behavioral attributes to generate an overall comparison result.

9. The system of claim 6, wherein the peer group selecting includes determining a similarity between and among the target claim and other claims for insurance payment with respect to claim attributes other than the set of behavioral attributes.

10. The system of claim 6, further including means for prospectively instructing an investigation the subrogation potential based on a result of the behavior comparing.

11. A computer program product for evaluating a subrogation potential of a target claim for insurance payment, the computer program product comprising:
computer usable program code configured to:
select a peer group of claims that are expected to include a similar behavior as the target claim and have been successfully subrogated;
identify a set of behavioral attributes of the peer group;
determine a normal behavior of the peer group regarding the identified set of behavioral attributes; and
compare a behavior of the target claim to the normal behavior regarding the identified set of behavior attributes to evaluate the subrogation potential of the target claim.

12. The program product of claim 11, wherein the program code is further configured to collect data of behaviors of the peer group and analyze the collected behavior data of the peer group regarding the identified set of behavioral attributes.

13. The program product of claim 11, wherein the program code is further configured to:
compare the behavior of the target claim with the normal behavior with respect to each of the identified set of behavioral attributes; and
combine a result of the comparison with respect to each of the identified set of behavioral attributes to generate an overall comparison result.

14. The program product of claim 11, wherein the program code is further configured to determine a similarity between and among the target claim and other claims for insurance payment with respect to claim attributes other than the set of behavioral attributes.

15. The program product of claim 11, wherein the program code is further configured to prospectively instruct an investigation of the subrogation potential based on a result of the behavior comparison.

16. A method of generating a system for evaluating a subrogation potential of a target claim for insurance payment, the method comprising: providing a computer infrastructure operable to:
select a peer group of claims that are expected to include a similar behavior as the target claim and have been successfully subrogated;
identify a set of behavioral attributes of the peer group;
determine a normal behavior of the peer group regarding the identified set of behavioral attributes;
compare a behavior of the target claim to the normal behavior regarding the identified set of behavior attributes to evaluate the subrogation potential of the target claim; and
communicate a result of the evaluation to a customer insurance company.

17. The method of claim 16, wherein computer infrastructure is further operable to collect data of behaviors of the peer group and analyze the collected behavior data of the peer group regarding the identified set of behavioral attributes.

18. The method of claim 16, wherein computer infrastructure is further operable to:
compare the behavior of the target claim with the normal behavior with respect to each of the identified set of behavioral attributes; and
combine a result of the comparison with respect to each of the identified set of behavioral attributes to generate an overall comparison result.

19. The method of claim 16, wherein computer infrastructure is further operable to determine a similarity between and among the target claim and other claims for insurance payment with respect to claim attributes other than the set of behavioral attributes.

20. The method of claim 16, wherein computer infrastructure is further operable to prospectively instruct an investigation of the subrogation potential based on a result of the behavior comparison.
